(19) United States
(12) Patent Application Publication
(10) Pub. No.: US 2008/0271611 A1
(43) Pub. Date: Nov. 6, 2008

(54) Machine for heating and dispensing liquid or semi-liquid food products

(76) Inventors: Gino Cocchi, Bologna (IT); Antonio Vannini, Vergato (IT)

Correspondence Address: Harbin King & Klima, 500 Ninth Street SE, Washington, DC, 20003, US

(21) Appl. No.: 12/149,126

(22) Filed: Apr. 28, 2008

(30) Foreign Application Priority Data
May 3, 2007 (IT) BO2007A000315

(51) Int. Cl. G07F 9/10

(52) U.S. Cl. 99/357

(57) ABSTRACT

The machine for heating and dispensing liquid or semi-liquid food products comprises a tank for containing a product to be dispensed, a central body supporting the tank, a tap for dispensing the product from the tank, stirring means for mixing the product in the tank, and a boiler for heating a predetermined quantity of water.

### BACKGROUND OF THE INVENTION

The present invention relates to a machine for preparing and dispensing liquid or semi-liquid food products.

In particular, the present invention lies within the sector of machines for heating and dispensing hot liquid or semi-liquid food products, such as liquid chocolate or the like.

For some time now there have been prior art devices for cooking and then keeping at a predetermined temperature, particularly suitable and appreciated by consumers, liquid chocolate for serving in cups.

Such prior art devices comprise a tank which contains the liquid product and a tap for dispensing the product. The tank consists of a cylindrical wall, usually transparent and, at the base of said cylindrical wall, a concave container, whose bottom portion is inserted in a boiler for heating water, designed to heat the product using the double boiler system.

In other words, since the concave body is at least partly immersed in the hot water, the product present in the container is heated and kept at a predetermined temperature thanks to the heat transmitted from the water to the wall of the concave body.

The machine also comprises mixing means designed to guarantee product homogeneity as well as uniformity of the temperature of the product throughout the whole container.

Obviously, especially in the case of liquid chocolate, said tank tends to get dirty very quickly and the successive heating and cooling cycles, to which the product is normally subjected, always cause the formation of deposits and build-ups, particularly in the concave container.

Moreover, for example in the case of chocolate, it is kept for a relatively short period of time, at the end of which, not necessarily due to any decline in its organoleptic properties but even simply due to the natural loss of its typical aroma, it must be substituted with new product.

Substitution of the product in the tank requires simultaneous thorough cleaning of the tank, removing any trace of the product it previously contained.

In prior art machines, said cleaning operation is particularly complex and laborious, both due to the complexity of machine construction and to the ease with which product deposits form in the most hidden parts of the tank, above all in the concave container forming the bottom of the tank.

### SUMMARY OF THE INVENTION

The technical purpose which forms the basis of the present invention is therefore to provide a machine for heating and dispensing liquid or semi-liquid food products which overcomes the above-mentioned disadvantages.

Within the scope of said technical purpose, an important aim of the invention is to provide a machine for heating and dispensing liquid or semi-liquid food products which allows easy cleaning and maintenance of its parts.

The technical purpose indicated and the aim specified are substantially achieved by a machine for heating and dispensing liquid or semi-liquid food products comprising one or more of the technical solutions described in the claims herein.

### BRIEF DESCRIPTION OF THE DRAWINGS

The advantages of the present invention are more apparent in the detailed description which follows, with reference to the accompanying drawings which illustrate a preferred, non-limiting embodiment of the invention, in which:

FIG. 1 is a perspective top view of a machine for preparing and dispensing liquid or semi-liquid food products in accordance with the present invention;

FIG. 2 is a schematic cross-section of the machine of FIG. 1;

FIG. 3 is a perspective top view of a disassembled component of the machine illustrated in the previous figures;

FIG. 4 is an enlarged perspective view of a detail of the machine of FIG. 1;

FIG. 5 is a perspective bottom view with some parts cut away to better illustrate others of the machine of FIG. 1.

### DESCRIPTION OF THE PREFERRED EMBODIMENTS

With reference to the accompanying drawings, the numeral 1 denotes a machine for heating and dispensing liquid or semi-liquid food products.

The machine 1 comprises a tank 2 for containing a food product, not illustrated, to be prepared and dispensed. As shown in the accompanying drawings, the machine 1 is preferably of the type designed for preparing and dispensing hot liquid or semi-liquid food products, such as liquid chocolate to be served in cups.

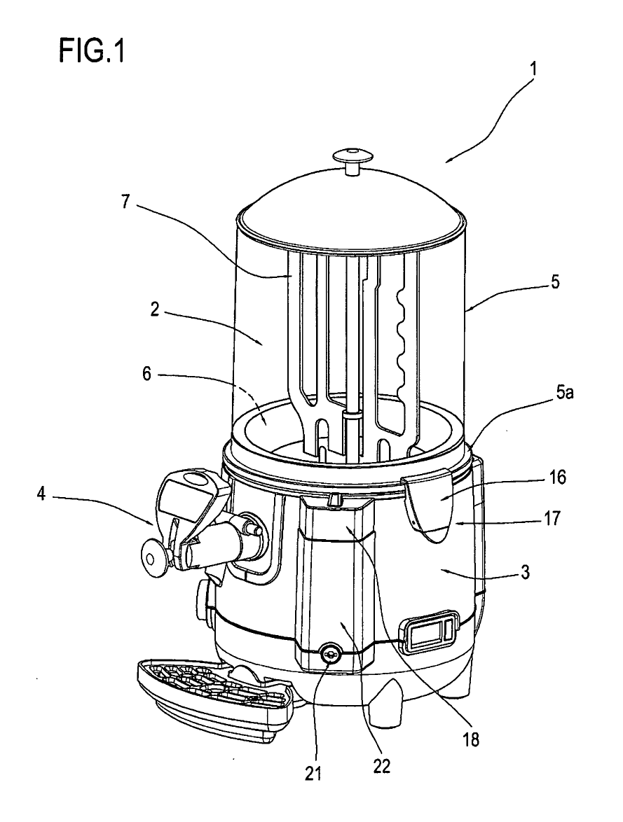

As illustrated in FIG. 1, the machine 1 comprises a central body 3 supporting the tank 2 and, emerging from the side of the central body 3, a tap 4 for dispensing the product from the tank 2.

The central body 3 also forms an outer body for the machine 1.

The tank 2 for containing the product comprises a cylindrical lateral wall 5, advantageously transparent and made of glass, and a concave bottom container 6 positioned below the lateral wall 5.

Inside the tank 2 there is a product mixing blade 7, the blade 7 rotatably connected to a vertical tubular column 8, emerging from the concave bottom container 6. There are electric motor elements 9, designed to drive the blade 7, housed in the central body 3.

The blade 7, together with the motor elements 9, forms for the machine 1 respective stirring means 10 for mixing the product.

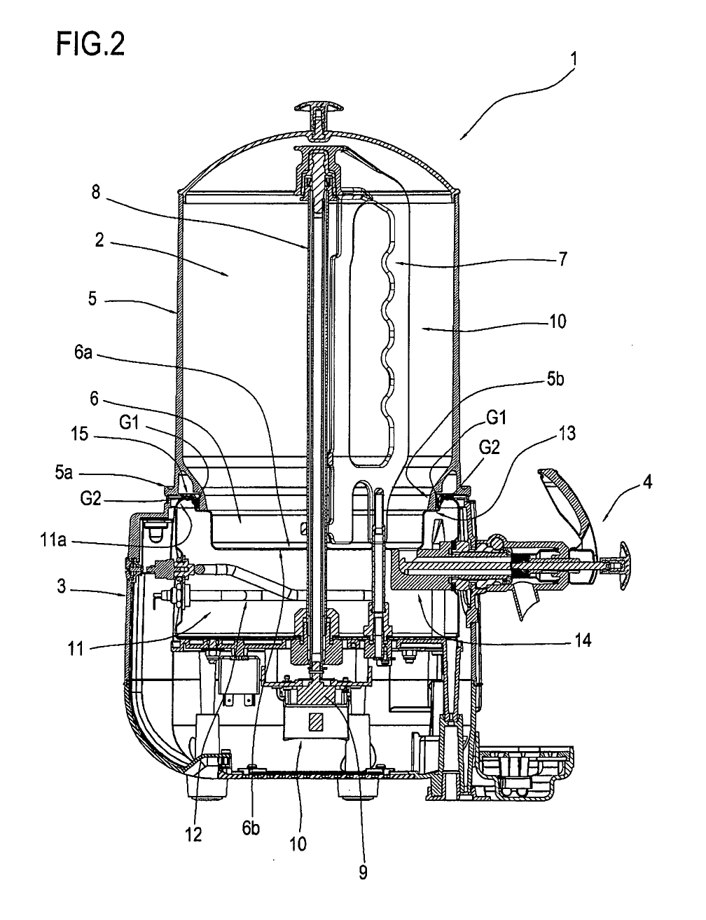

As illustrated in FIG. 2, the machine 1 comprises a boiler 11 for heating water, the boiler 11 being housed in the central body 3. The boiler 11 comprises, as water heating means, one or more electric heating elements 12 immersed in the water.

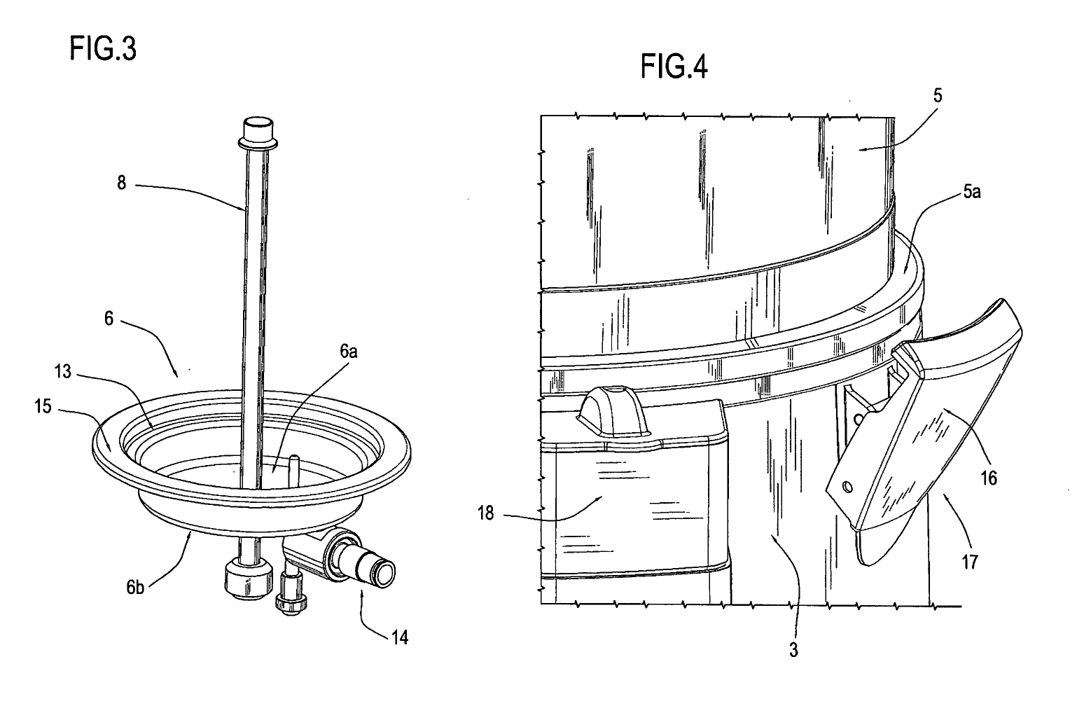

As illustrated in FIGS. 2 and 3, the concave container 6 has an upper face 6a and a lower face 6b which gives onto the boiler 11 and is in contact with the water, not illustrated, contained in the boiler 11. In other words, the concave container 6 is partly housed in the boiler 11.

The upper face 6a, which is in contact with the food product, has a surface coating layer made of non-stick material.

Experimentation has shown that excellent results are obtained when using a semicrystalline thermoplastic polymer as the non-stick material.

Good results were also achieved with fluoropolymer-based non-stick materials.

Alternatively, with satisfactory results, the surface coating layer is obtained using a metallization process not described in this text. In said case the surface layer is said to be metalized.

Another alternative solution involves using ceramic material to make the non-stick coating layer.

With reference to FIG. 3, the concave container 6 is circular, having a step 13 and comprises a food product outfeed pipe 14, the pipe 14, as illustrated in FIG. 2, being designed to engage with the dispensing tap 4.

As illustrated in FIG. 2, the lower zone of the lateral wall 5 has an annular edge 5a projecting radially outwards relative to the wall 5 and an annular foot 5b which narrows inwards.

The annular edge 5a engages in contact with a corresponding flat annular portion 15 of the concave container 6, whilst the annular foot 5b rests on the concave container 6 step 13. An annular seal G1 is inserted between the concave container 6 and the annular foot 5b, on the outside of the latter.

With reference to FIG. 5, the machine 1 comprises, positioned in such a way that they are diametrically opposed to each other relative to the substantially circular perimeter of the central body 3 and connected to the latter, two snap-on hooks 16 designed to connect the lateral wall 5 to the central body 3.

In detail, as illustrated in FIG. 2, the flat annular portion 15 of the container 6 rests, with a seal G2 inserted between them, on an upper portion 11a of the boiler 11 and, in turn, as already indicated, the annular edge 5a of the lateral wall 5 engages in contact on the flat annular portion 15.

The hooks 16, acting on the annular edge 5a, press the annular edge in contact with the flat annular portion 15 and the latter against the upper portion 11a of the boiler 11, and all of them against the central body 3.

Obviously, when the annular edge 5a is forced against the concave container 6, the annular foot 5b of the lateral wall 5 is also forced to adhere perfectly to the concave container 6 step 13, thus creating a sealed connection between the container 6 and the lateral wall 5 of the tank 2.

In FIGS. 1 and 5 the hooks 16 are illustrated in their closed configuration in which perfect assembly of the various machine 1 components is guaranteed.

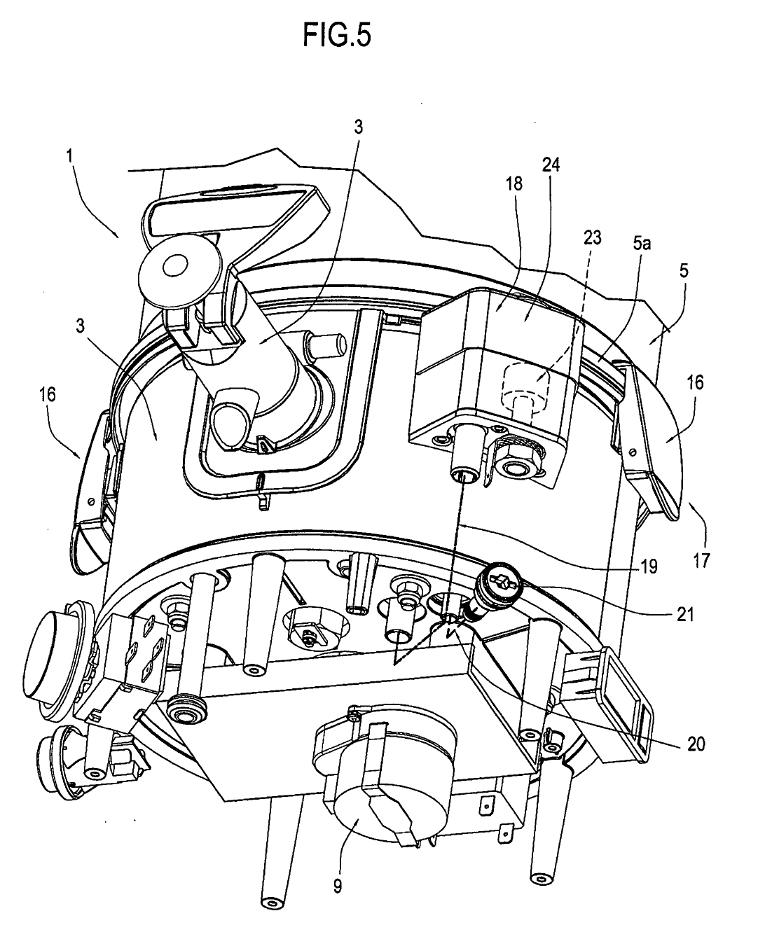

FIG. 4 shows a hook 16 open configuration, in which the tank 2 can be removed.

For the machine 1, the snap-on hooks 16 form elements 17 for retaining the lateral wall 5 of the tank 2 on the central body 3.

The machine 1 also comprises a watertight chamber 18, projecting from the side of the central body 3. Extending from the chamber 18 there is a first pipe 19 for filling the boiler 11. The pipe 19 therefore puts the chamber 18 and the boiler 11 in liquid communication with each other.

FIG. 5 illustrates two portions, respectively the start and end portions, of the pipe 19 and, schematically with a dashed and dotted line, the connection between said portions.

Extending from the bottom of the boiler 11 there is a second pipe 20 for draining water from the boiler 11. This second pipe 20 leads to the outside of the machine 1 and is advantageously closed with a plug 21. Similarly to the first pipe 19, FIG. 5 shows only a starting portion of the second pipe 20 and the closing plug 21. A dashed line schematically illustrates the rest of the second, drainage pipe 20.

As illustrated in FIG. 1, a projecting portion 22 of the central body 3 at least partly hides from view and protects the first and second pipes.

The chamber 18 houses a float detector element 23 for detecting the water level in the chamber 18 and, due to the connection guaranteed between the chamber and the boiler 11 by the first pipe 19, also the water level in the boiler 11.

The float element 23 controls a relative switch, not illustrated, which switches off the boiler 11. Since, advantageously, the boiler is of the electric type, heating the water using heating elements 12, the Off switch, controlled by the float element 23, cuts the electrical power supply to the heating elements 12 when the water level drops below a predetermined element 23 calibration value.

The chamber 18, together with the float detector element 23, forms, for the machine 1, means 24 for measuring the water level in the boiler 11.

In practice, during preparation of a liquid or semi-liquid food product using the machine 1, for example chocolate for drinking in a cup, the tank 2 is filled with product, with activation of both the stirring means 10 and the boiler 11, in which the water therefore begins to be heated by the electric heating elements 12.

When the water reaches the temperature set, the step of double boiler cooking of the product begins, advantageously controlled by a thermostat, not illustrated, like the subsequent step of keeping the product at a temperature lower than that necessary for actual cooking.

During the steps of cooking the product and keeping it at the required temperature, heat is transmitted through the concave container 6 and, in particular, between the hot water in the boiler, in contact with the lower face 6b of the container 6 and the food product, which is in contact with the upper face 6a of the container 6.

Advantageously, use of the surface coating layer for the upper face 6a made of non-stick material means that any product deposit on the upper face 6a is easy to remove during regular machine cleaning operations.

Moreover, advantageously, the surface layer makes it even more difficult for deposits to form, since it facilitates product sliding.

The regular cleaning operations are also facilitated by the presence of removable elements 17 for retaining the vertical cylindrical wall 5 on the machine 1 central body 3.

Said elements 17, consisting of snap-on hooks 16, allow secure fixing of the wall 5 and the entire tank 2 to the body 3 and, at the same time, when required, make disassembly of said components particularly simple and fast.

In this way, when the operator wants to clean the tank 2, he can simply open the hooks 16 and, after removing the blade 7 from the column 8, remove the cylindrical vertical wall 5 to wash it. Once the cylindrical wall 5 has been removed, a moist cloth is all that is needed to clean the concave bottom container 6, since, thanks to the surface coating layer made of non-stick material any product residues on its upper face 6a are much smaller and, if present, are extremely easy to remove.

If, while the machine 1 is being used, for a variety of reasons, including evaporation, the water level in the boiler 11 drops dangerously, since, thanks to the first pipe 19, the same level is also maintained in the chamber 18, a drop below a predetermined level would result in the simultaneous lowering of the float element 23 and the consequent switching off of the boiler 11 by activation of the above-mentioned Off switch, not illustrated.

Advantageously, the presence of the float element 23 and the relative Off switch guarantees a high level of safety when using the machine 1.

Moreover, the first, filling pipe 19 and the second, drainage pipe 20 can be used to guarantee the water level in the boiler 11 and relative regular changing of the water, without internal machine 1 parts having to be disassembled or the machine having to be tilted, which would risk uncontrolled outflows of water.

Therefore, the invention allows maintenance on the machine to be simplified and made very effective.

The invention described above may be modified and adapted without thereby departing from the scope of the inventive concept defined in the claims herein.

1. A machine for heating and dispensing liquid or semi-liquid food products, comprising:
a tank (2) for containing a product to be dispensed, the tank (2) comprising a cylindrical lateral wall (5) and a concave bottom container (6),
a central body (3) supporting the tank (2),
a tap (4) for dispensing the product from the tank (2),
stirring means (10) for mixing the product in the tank (2),
a boiler (11) for heating a predetermined quantity of water, the concave bottom container (6) being at least partly housed in the boiler (11) so that it is in contact with the water, wherein the concave bottom container (6) comprises a surface coating layer made of non-stick material, at least on its upper face (6a) which is in contact with the product.

2. The machine according to claim 1, wherein the non-stick material is a polymer.

3. The machine according to claim 2, wherein the polymer is a fluoropolymer.

4. The machine according to claim 2, wherein the polymer is thermoplastic and semicrystalline.

5. The machine according to claim 1, wherein the surface layer is metalized.

6. The machine according to claim 1, wherein the non-stick material is a ceramic material.

7. The machine according to claim 1, wherein it comprises removable elements (17) for retaining the lateral wall (5) on the central body (3).

8. The machine according to claim 7, wherein the removable retaining elements (17) comprise at least one snap-on hook (16).

9. The machine according to claim 8, in which the cylindrical lateral wall (5) has a lower annular edge (5a) projecting radially relative to the wall (5), wherein the hook (16) engages by gripping on the annular edge (5a).

10. The machine according to claim 8, wherein the removable retaining elements (17) comprise two hooks (16) positioned in such a way that they are diametrically opposed to each other along a substantially circular perimeter of the central body (3).

11. The machine for heating and dispensing liquid or semi-liquid food products, in particular according to claim 1, wherein it comprises a first pipe (19) for filling a boiler (11) designed to heat water, and a second pipe (20) for draining water from the boiler (11).

12. The machine according to claim 11, wherein it comprises a chamber (18) which is separate from the boiler (11), the first pipe (19) for filling the boiler (11) extending from the chamber (18), the first pipe (19) putting the boiler (11) and the chamber (18) in fluid communication with each other.

13. The machine according to claim 12, wherein it comprises means (24) for measuring the water level in the boiler (11), said measuring means (24) comprising a float detector element (23) housed in the chamber (18).

14. The machine according to claim 13, wherein it comprises a boiler (11) Off switch, the switch being controlled by the float detector element (23) so that the boiler (11) is switched off if there is a predetermined drop in the water level in the boiler (11).
